(19) United States
(12) Patent Application Publication
(10) Pub. No.: US 2010/0184342 A1
(43) Pub. Date: Jul. 22, 2010

(54) Method for responding to a missing marine propulsion device

(75) Inventor: Scott M. Olig, Oshkosh, WI (US)

Correspondence Address: WILLIAM D. LANYI, MERCURY MARINE, W6250 PIONEER ROAD P.O. BOX 1939, FOND DU LAC, WI, 54936-1939, US

(73) Assignee: Brunswick Corporation

(21) Appl. No.: 11/973,570

(22) Filed: Oct. 9, 2007

(51) Int. Cl. B63H 21/21; G01S 1/00

(52) U.S. Cl. 440/84; 342/357.07; 340/984

(57) ABSTRACT

A missing outboard motor system provides a microprocessor of the outboard motor with the ability to disable or cause a malfunction of the engine of the outboard motor. This disabling of the outboard motor engine can be programmed to occur upon the detection of tampering relating to a communication system. A global positioning satellite system can be provided to monitor the current position of the outboard motor and report that current position to a remote source, such as a monitoring station. The malfunction that can be caused with regard to the engine can be minor and temporary, but severe enough to induce a thief or co-conspirator to attempt to have the outboard motor repaired. This will assist in relocating the outboard motor and capturing the thief.

### BACKGROUND OF THE INVENTION

1. Field of the Invention

The present invention is generally related to a method for responding to a missing marine propulsion device and, more particularly, to a method for locating a stolen outboard motor.

2. Description of the Related Art

Since the development of global positioning satellite (GPS) systems and cellular telephone systems, many different types of tracking and monitoring devices and systems have been developed. As will be described immediately below, these known types of systems vary from monitoring systems for human beings, in which transceivers are implanted within the body of people, to similar transceivers and GPS systems that are incorporated within the structure of items that are potentially subject to theft. The systems are intended to track stolen objects in order to aid the recovery of those objects by law enforcement agencies.

U.S. Pat. No. 4,706,689, which issued to Man on Nov. 17, 1987, describes an implantable homing device for monitoring of humans. The device employs a unique programmable signal generator and detection system to locate and monitor the movement of individuals. It additionally utilizes a physiological monitoring system to signal a warning for the necessity for immediate help. The device is small enough to be implanted in young children as well as adults. The power supply and signal generator are designed to function at a low duty cycle for prolonged periods before recharging.

U.S. Pat. No. 5,418,537, which issued to Bird on May 23, 1995, describes the location of missing vehicles. It uses a global positioning system that receives GPS signals from two or more GPS satellites. A GPS antenna, receiver/processor, a paging responder, a cellular telephone and associated antenna, and a controller/modem are installed in a vehicle and electrically connected together. When the vehicle is determined to be missing, because the vehicle has been misplaced, lost or stolen, the vehicle owner or operator contacts a vehicle location service center which broadcasts a paging request that is received by the paging responder on the vehicle. The responder causes the controller/modem to interrogate the GPS receiver/processor to determine the present location of the vehicle. The receiver/processor determines the present vehicle location and notifies the controller/modem of such location.

U.S. Pat. No. 5,576,716, which issued to Sadler on Nov. 19, 1996, describes an owner oriented system for locating lost or stolen property. It comprises a GPS module, microcomputer, modem and a phone installed in a vehicle. Regular and automatic computing position data are used and under control of a program storing novel position data in a buffer and downloading upon proper request from an incoming call are performed.

U.S. Pat. No. 5,703,598, which issued to Emmons on Dec. 30, 1997, describes a method and system of tracking stolen property. It uses a continuously powered radio receiver for receiving encoded signals from a central station. When the received signal corresponds to a unique code stored at the receiver, a GPS receiver and a radio transmitter located within the stolen property are connected for a predetermined period of time to a source of power so that a GPS signal received by the receiver is processed and the position data produced thereby is transmitted to the central station.

U.S. Pat. No. 5,796,365, which issued to Lewis on Aug. 18, 1998, describes a method and apparatus for tracking a moving object. It is based on signals transmitted from a plurality of satellites rotating about the earth in known orbits. First, the latitude and longitude of a fixed point is determined with accuracy. The object is capable of moving with respect to the fixed point. Second, the satellite signals are received at the fixed point and processed to determine the approximate latitude and longitude of the fixed point. A first difference between the accurate and approximate latitudes is taken to provide a differential latitude correction of a magnitude corresponding to the first difference and of a direction to the north or south. A second difference between the accurate and approximate longitudes is also taken to provide a differential longitude correction of a magnitude corresponding to the second difference and of a direction to the west or east.

U.S. Pat. No. 6,239,705, which issued to Glen on May 29, 2001, describes an intra oral electronic tracking device. An improved stealthy, non-surgical, biocompatible electronic tracking device is provided in which a housing is placed intra orally. The housing contains microcircuitry. The microcircuitry comprises a receiver, a passive mode to active mode activator, a signal decoder for determining positional fix, a transmitter, an antenna, and a power supply. U.S. Pat. No. 6,611,229, which issued to Muramatsu et al. on Aug. 26, 2003, describes a vehicle tracking system, vehicle theft warning system, stolen vehicle tracking system, and theft warning vehicle tracking system. A vehicle with GPS receivers specifies a previously registered member and the vehicle owned by the previously registered member based upon a request of the previously registered member for providing positional information of a vehicle owned by the previously registered member. The vehicle tracking system executes a polling operation of positional information to the vehicle owned by the previously registered member.

It retrieves an existence position of the vehicle on a map from a map database based upon positional information transmitted from the vehicle owned by the previously registered member.

U.S. Pat. No. 6,801,129, which issued to Grimm on Oct. 5, 2004, describes a tracking system for locating stolen currency. A security pack for assisting in the recovery of stolen money includes a housing disguised as a bundle of currency bills but containing a GPS receiver for receiving GPS signals from overhead satellites, a cellular phone transceiver, a microprocessor, and a battery. Following a bank robbery, the microprocessor activates the cellular phone transceiver to dial the telephone number of a central monitoring station. The microprocessor obtains location data from the GPS receiver and transmits the location data, along with identification information, to the central monitoring station.

U.S. Pat. No. 7,024,308, which issued to Oesterline et al. on Apr. 4, 2006, describes a telematic method for real-time routing to stolen vehicles. It includes a first telematic unit incorporated within a stolen vehicle, a call center, and a second telematic unit incorporated with a police vehicle. The telematic system implements a method for real time routing to the stolen vehicle. The method cyclically involves a determination of the GPS coordinates of the stolen vehicle and the police vehicle by the respective telematic unit, a calculation of the complete route from the police vehicle to the stolen vehicle, and a calculation of a partial route extending from the police vehicle to the stolen vehicle.

U.S. Pat. No. 7,102,508, which issued to Edelstein et al. on Sep. 5, 2006, describes a method and apparatus for locating and tracking persons. The apparatus is an implantable device composed of biocompatible materials in all areas where contact with the organic tissue occurs. The gross anatomic siting of the device includes any limb, the torso, including back and perineum, the neck, and the head. The surgical anatomic siting of the device includes supramuscular, intramuscular, submuscular, intraluminal and intracavitary.

U.S. Pat. No. 7,138,916, which issued to Schwartz et al. on Nov. 21, 2006, describes a computerized risk management program. It provides a method to inventory articles, to locate lost or stolen articles and to recover a lost or stolen article. The system applies an electronic tag to each article of a multiplicity of articles or only to a valuable article and employs a computer to maintain an inventory of all articles. Use is made of the global positioning system to locate a lost or stolen article as well as to track movement of the article. A history of the movement of the article may also be plotted on a map. An electronic geographic boundary area may also be placed around an article that can be used to emit a signal indicative of the article leaving the area.

U.S. Pat. No. 7,248,170, which issued to DeOme et al. on Jul. 24, 2007, describes an interactive personal security system. The system utilizes a portable object having embedded therein all or a combination of a microphone, stolen video cameras, distance sensor, timer, speakers, a motion sensor, a tracking transponder, a receiver, and a transmitter operably connected to a power source and a conventional microprocessor including input devices, random access memory, read only memory and a database. Sounds and images are transmitted to remote monitoring stations by radio waves or microwaves for radio or television broadcasting or recording on a tape recorder or VCR. Alarms are transmitted to telephones and beepers. Face and voice recognition software identifies the people speaking, playing or attempting to kidnap the child. Sensors identify the presence of persons or animals or a child wandering out of the restricted area. Speakers allow guardians to communicate two-way with a child, thereby responding to the immediate needs of the child. Tracking transponder allows for a pinpoint location of the portable object.

The patents described above are hereby expressly incorporated by reference in the description of the present invention.

Many different applications have been developed for tracking or locating stolen objects through the use of GPS systems and cellular telephones. The systems, as described above, provide information relating to the location of the stolen object and facilitate the finding of the object and/or arrest of the thief who stole the object. However, it is to be expected that thieves will soon learn that to certain objects are equipped with these types of systems and, as a result, will learn that disabling the GPS system and/or the cellular telephone can defeat them. In addition, in recent years it has become more common that outboard motors are being stolen from marine vessels. Locks and other security systems are initially destroyed and outboard motors are then removed from the marine vessels. The easy portability of outboard motors makes these objects relatively easy targets of thieves. It would therefore be significantly beneficial if a system could be provided to help to locate and retrieve stolen outboard motors and, in addition, it would be particularly helpful and beneficial if the intentional disabling of the GPS system and/or the communication system could be made highly disadvantageous. Furthermore, if the communication system and/or GPS system is defeated by a thief, it would be beneficial if an alternative means of locating the stolen outboard motor and subsequent arrest of the thief could be facilitated.

### SUMMARY OF THE INVENTION

A method for responding to a missing marine propulsion device, in accordance with a preferred embodiment of the present invention, comprises the steps of providing a communication system comprising a receiver, providing a microprocessor which is configured to control the operation of an engine of the marine propulsion device in which the microprocessor is connected in signal communication with the receiver, receiving a message from a remote source relating to the marine propulsion device, determining if the message relates to a missing status of the marine propulsion device, and causing the marine propulsion device, in response to the message relating to the missing status of the marine propulsion device, to malfunction in a preselected manner.

The causing step can cause the microprocessor to prevent the engine from starting, to prevent the engine from operating above idol speed, or to prevent the to engine from operating for longer than a preselected period of time. The causing step can also include other types of malfunction which will be described in greater detail below.

The communication system can further comprise a transmitter and the step of transmitting a response to the remote source acknowledging receipt of the message previously transmitted from the remote source. In certain embodiments of the present invention, it can further comprise the steps of providing a global positioned satellite system receiver, receiving a current position of the marine propulsion device, and transmitting the current position to the remote source. In certain embodiments of the present invention, it can further comprise repeating the current position transmitting step periodically in response to receipt of the method relating to the missing status of the marine propulsion device. In addition, a preferred embodiment of the present invention can further comprise the step of transmitting an operability status inquiry to the remote source. This transmitting step can typically be accompanied by a further step of determining, in response to the operability status inquiry transmitting step, if the communication system is operating properly and then causing the marine propulsion device, in response to a determined inoperability status of the marine propulsion device, to malfunction in a preselected manner.

### BRIEF DESCRIPTION OF THE DRAWINGS

The present invention will be more fully and completely understood from a reading of the description of the preferred embodiment in conjunction with the drawings, in which:

FIG. 1 illustrates a highly simplified embodiment of the present invention using only a receiver;

FIG. 2 shows an embodiment of the present invention with a transmitter and receiver;

FIG. 3 is an embodiment of the present invention with a global position satellite receiver, a transmitter, and a receiver in addition to the engine control unit and ignition system; and

FIGS. 4-7 are simplified flowcharts of various software functions that are performed by various preferred embodiment of the present invention.

### DESCRIPTION OF THE PREFERRED EMBODIMENT

Throughout the description of the preferred embodiment of the present invention, like components will be identified by like reference numerals.

Many different systems are known to those skilled in the art of tracking stolen objects and reporting the location of those stolen objects. Typically, a GPS system is used to determine the precise location of the stolen object. A transmitter/receiver, such as a cellular telephone, is used to contact a remote station in order to report the location of the stolen object and, if the object is being moved, periodically report new locations where the stolen object can be found. This information can be reported to law enforcement personnel who can follow the GPS directions, in terms of longitude and latitude, and locate the stolen property. These types of systems have been known for years in conjunction with valuable objects that can be stolen and, in some cases, to finding human beings who are subject to getting lost or kidnapped. These concepts are well known and many different adaptations have been developed, as illustrated above in the description of the related art.

When an object is provided with a GPS system and/or a cellular telephone system, a thief may be able to disable the system by locating and damaging the GPS receiver and/or cellular telephone or, more simply, by locating and disabling the antenna for one or both of these devices. If the communication system, such as the cellular telephone, is disabled, the tracking system will be unable to communicate the GPS location to the remote station and the intended result will be defeated.

A preferred embodiment of the present invention is intended to provide a theft inhibiting system and a missing marine propulsion device locating system that can achieve the intended results even if the thief attempts to disable the communication system and/or the GPS system. Several embodiments of the present invention will be described herein. It should be understood that certain embodiments are significantly preferred relative to other embodiments, but that each of embodiments of the present invention, regardless of its complexity or simplicity, will assist in responding to a missing marine propulsion device, such as an outboard motor. Some of the embodiments will more quickly result in a recovered marine propulsion device than others, but they are all intended to inhibit the theft of outboard motors and assist in their recovery if a theft occurs.

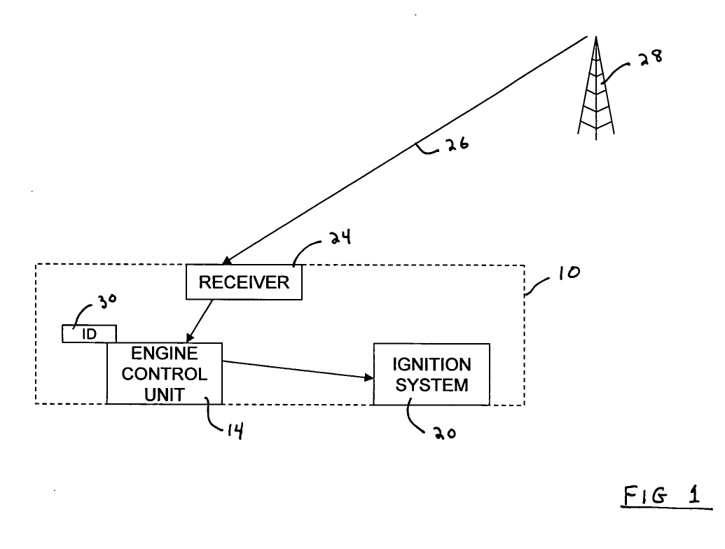

FIG. 1 shows a basic embodiment of the present invention. An outboard motor is represented schematically by dashed line box 10. It is provided with an engine control unit 14 that comprises a microprocessor that is programmed to control the operation of an engine of the outboard motor 10. Engine control units are well known to those skilled in the art who recognize that the microprocessor of the engine control unit controls the fueling, ignition timing, and throttle position systems of the engine. In addition, the engine control unit performs many other functions, such as monitoring the engine speed and responding to various operator commands. The system shown in FIG. 1 illustrates the relationship between the engine control unit 14 and an ignition system 20. The engine control unit 14 typically controls the ignition timing and firing sequence of the spark plugs of the engine as a function of the operating speed of the engine. The outboard motor 10 is provided with a communication system that comprises a receiver 24. The receiver is equivalent to the receiving portion of a cellular telephone that receives signals 26 from a cellular tower 28 in the manner that is well known to those skilled in the art. In other words, the receiver 24 is able to receive calls from remote stations in the way that cellular telephones receive telephone calls.

With continued reference to FIG. 1, an identification (ID) location 30 is illustrated in association with the engine control unit 14. The identification 30 is a unique identifying number or name associated with the outboard motor 10. As will be described in greater detail below, the identification 30 will be used in conjunction with communication between the remote station and the outboard motor 10 in order to assure that mistaken or misidentified telephone calls are not inadvertently able to cause disruption of a normal operation of the outboard motor. In a simplest and basic embodiment of the present invention, the owner of the outboard motor 10 would contact the manufacture of the outboard motor 10 or, in certain cases, a service provider used for the purposes of finding missing outboard motors. The theft or missing outboard motor would be reported to that remote station and a telephone call would be placed to the receiver 24 which provides the proper identification number 30 associated with the outboard motor 10 and a brief message alerting the microprocessor of the engine control unit 14 that the outboard motor is missing and possibly has been stolen. In this simplest embodiment shown in FIG. 1, the engine control unit would then act in a preselected manner to cause the engine to malfunction. Several optional methods can be used to perform this task. As an example, since the engine control unit 14 controls the ignition system 20, it can limit the operating speed of the engine to idle speed and no higher. In other words, the microprocessor would allow the engine to operate properly, but only up to approximately 600 to 700 RPM. Regardless of any attempt by the operator to increase the speed beyond idle speed, the engine would not be permitted to respond. Alternatively, the ignition system 20 could be completely disabled so that the engine would not start at all. Another optional method of causing this malfunction would be to allow the engine to operate for a preselected period of time, such as two minutes, in a normal manner and then cease operating completely. Each time the engine is restarted, it could be allowed to operate for that same preselected period of two minutes and then the engine would be stopped. Each of these types of malfunction could be selected with the intent of causing the thief, or a person buying the engine from a thief, to go to a dealer or the manufacturer of the outboard motor in order to seek repair of the malfunctioning engine. The serial number of the engine would already have been associated with the report of the missing outboard motor. When the repairs are sought by the thief, or the party purchasing the outboard motor from the thief, the dealer or other repair facility would be expected to seek a replacement component (e.g. the engine control unit 14) and the serial number could then be matched to the stolen or missing outboard motor. At that point, law enforcement officials can be called in and the thief can be identified. The missing outboard motor can then be returned to the rightful owner. The method associated with the embodiment shown in FIG. 1 is somewhat limited in comparison to alternative embodiments because of the provision of only a receiver 24.

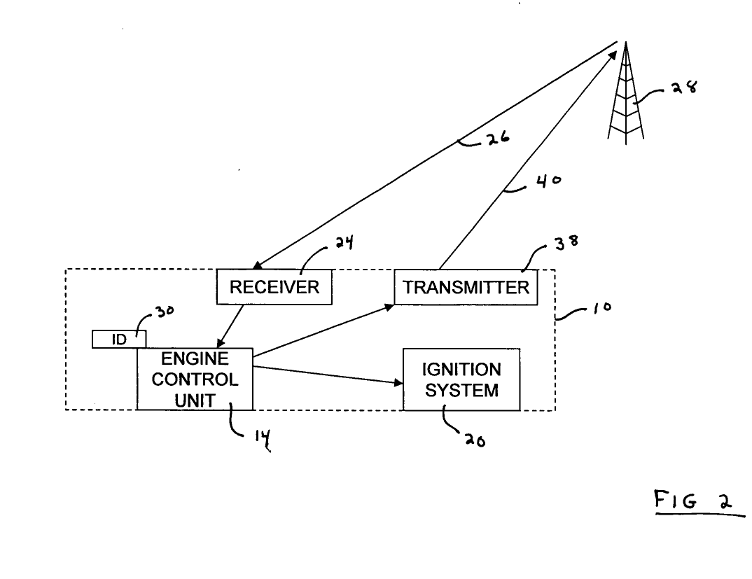

The embodiment of the present invention shown in FIG. 2 shows an embodiment of the present invention in which a transmitter 38 is also provided. Certain significant advantages can be achieved by the provision of both a receiver 24 and a transmitter 38. In the event that the outboard motor 10 is stolen and the thief makes an attempt to disarm the communication system by, for example, destroying the antenna, the provision of the transmitter and receiver can help to respond to this situation. In the embodiment described above in conjunction with FIG. 1, the engine control unit 14 can, possibly, periodically expect a communication from the remote station on a periodic basis (e.g. once every 10 hours). If that communication is not received at the expected time, the microprocessor can be programmed to assume that the antenna has been destroyed. It can then react to this assumed destruction by proceeding with the step of disabling the engine in such a way so as to cause one of the malfunctions described above. However, that basic embodiment shown in FIG. 1 requires certain assumptions concerning the damage to the antenna which may or may not be accurate. When the system is provided with a transmitter, such as the embodiment shown in FIG. 2, periodic checks can be made by the engine control unit 14 to see whether or not the communication system is operating properly. Rather than wait for periodic communications from the remote station, the engine control unit 14 can command the transmitter 38 to send an operability status inquiry, as represented by arrow 40, to the remote station in order to ask for a response so that the proper operation of the communication system can be checked. If a response is received, as represented by arrow 26, by the receiver 24, the engine control unit 14 can assume that the communication system is operating properly. As part of this inquiry, the identification 30 would typically be provided by the transmitter 38 in order to allow the remote station to recognize that the particular outboard 10 associated with the identification 30 has requested the inquiry and is operating properly at that time. If a theft is reported by the owner of the outboard motor 10, the remote station can transmit that information to the receiver 24, accompanied with the proper identification 30, and the engine control unit 14 can respond with a transmission from the transmitter 38 that the message has been properly received and that it will take the necessary steps to cause the malfunction of the engine.

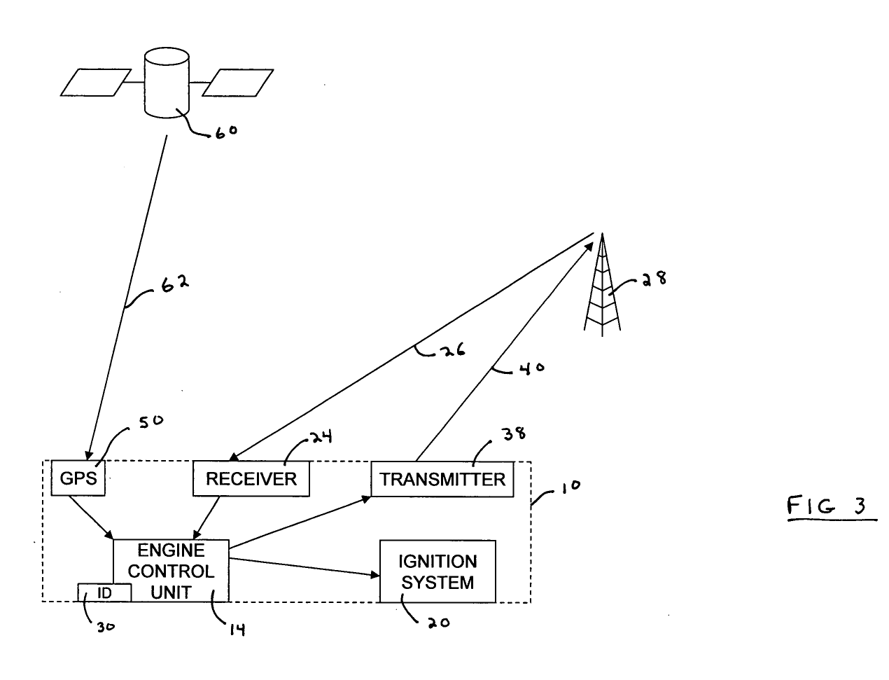

The embodiment of the present invention shown in FIG. 3 is generally similar to those described above, but with a GPS receiver 50 in addition to the transmitter 38 and receiver 24. In a manner generally known to those skilled in the art, a GPS receiver 50 receives signals from a GPS satellite 60, as represented by arrow 62, that represent the longitude and latitude of the GPS receiver 50. The arrangement of components shown in FIG. 3 allow the outboard motor 10 to respond to a report that it is stolen or missing with a much more sophisticated set is of information. As an example, when the receiver 24 receives an alert from the remote station that the outboard motor 10 has been stolen, it can immediately go into a mode of operation in which periodic GPS signals are received by the GPS receiver 50 and interpreted by the engine control unit 14 to define the precise location of the outboard motor 10 at any particular time. That information can then be sent from the transmitter 38 to the remote station accompanied by the identification 30. Upon each transmission of this type, as represented by arrow 40, the remote station will immediately know the precise location of the stolen outboard motor 10 and, if it is being moved, the direction in which it is being moved. The GPS readings can be updated at a relatively frequent basis and the reports transmitted by the transmitter 38 at that same frequent basis to the remote station. This allows law enforcement officials to pursue the stolen outboard motor 10. Simultaneously, the engine control unit 14 can take the steps described above relating to causing a malfunction of the engine. This would involve the limiting of the speed of the engine to idle speed, the intermittent shutting off of the engine after a brief period of time, or the complete disabling of the ignition system 10 to prevent the operation of the engine.

With continued reference to FIG. 3, it should be understood that the other functions described above in conjunction with FIGS. 1 and 2 can also be performed by the system shown in FIG. 3. For example, if a thief attempts to disable the system by destroying the antenna, or the GPS system 50, this can be detected through the status inquiry in which the engine control unit 40 attempts to communicate with the remote station by transmitting a message from the transmitter 38 and expecting an answer received by the receiver 24. If the answer is not received, the engine control unit 14 can be programmed to assume that some destruction was attempted relating to the antenna system. This, as described above, can be responded to through the causing of a malfunction of the engine. In addition, if the GPS system 50 fails to operate for any reason, this failure can be reported to the remote station through the use of the transmitter and the identification 30.

Any system of the type described above and those systems known to those skilled in the art can be defeated by a thief. In fact, as these systems become known to potential thieves, it should be expected that some attempts would be made to defeat them. These attempts can be as simple as disconnecting antenna wires or by attempting to destroy the transmitter, the receiver, or the GPS component. One of the primary intentions of the present invention is to inhibit that type of destruction by responding to it with a malfunction of the engine. If a thief destroys the security system, the outboard motor will be inhibited from operating properly. The type of malfunction can be selected in an attempt to induce the thief, or a person buying the stolen outboard motor, to approach a dealer or repair location that is aware of the theft. That will then allow law enforcement to recover the stolen outboard motor and, in certain circumstances, arrest the thief or the dealer of stolen goods.

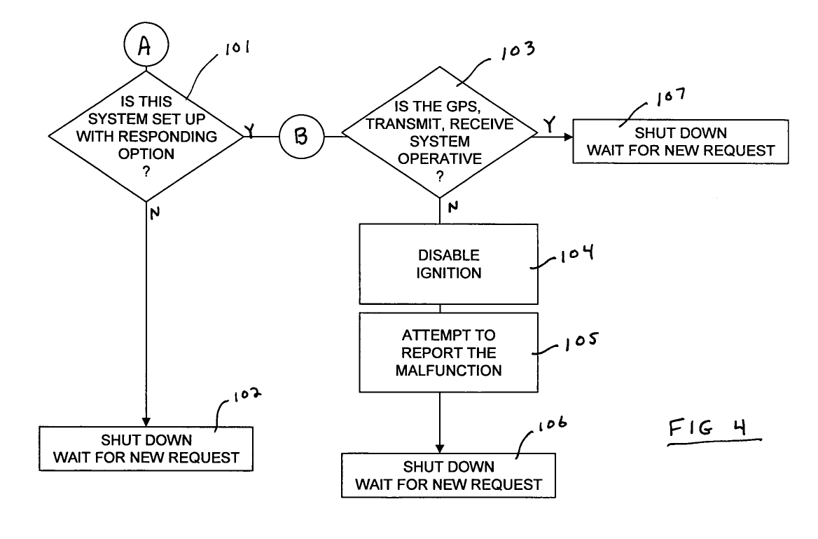

It should be understood that the present invention can be implemented in many different ways according to several different preferred embodiments. The following simplified flowcharts are provided to illustrate certain of those embodiments. In FIG. 4, the microprocessor of the engine control unit 14 interrogates its own status to determine whether or not it is currently set up to respond in cases of missing outboard motors. It should be understood that this feature can be operated as an option at the discretion of the owner of the outboard motor. It is anticipated that not every outboard motor owner will decide that the feature is desirable. When an owner of an outboard motor 10 decides that this method of responding to a missing marine propulsion device is a desirable feature, that decision can be memorialized within various flags and codes of the microprocessor. In FIG. 4, at functional block 101, the microprocessor determines whether or not this feature has been chosen. If it has not, this portion of the software is shut down at functional block 102 and the microprocessor waits for additional tasks to be performed. However, if the system is set up with the responding option, the software goes to point B and determines whether or not the GPS system, the transmitter, and the receiver are operative. This is done at functional block 103. It should be understood that the software represented in FIG. 4 is performed periodically and not necessarily following the receipt of a transmission from the remote station. The timing of this software operation can vary. For example, the routine shown in FIG. 4 can be performed every time the engine is started. Alternatively, it can be performed on a schedule, such as once every 10 hours of operation. It can possibly be on a schedule that is initiated at a particular clock time (e.g. 8:00 a.m.) or, alternatively, following every disconnection and reconnection of power (i.e. the battery connection) to the system. These options are not limiting to the present invention.

With continued reference to FIG. 4, the question asked at functional block 103 is intended to determine whether or not some type of tampering has occurred in order to disable the system which incorporates the GPS and the communication system. As described above, this can be a simple attempt to transmit an inquiry to the remote station with an expected answer. If the answer is not received, the microprocessor determines that the system is inoperative and proceeds to disable the ignition at functional block 104 and make an attempt to report the malfunction at functional block 105. Naturally, if the communication system has been effectively disabled, the attempt at functional block 105 might be unsuccessful. Following this, the software shuts down to wait for any new requests at functional block 106. If, on the other hand, the GPS and communication systems are operative, the microprocessor proceeds to functional block 107 and shuts down to wait for a new request. The simple algorithm shown in FIG. 4 can be performed on a preselected schedule or upon the occurrence of some event, such as a restoration of power (i.e. reconnecting the battery) or a restart of the engine. In a most typical application of this embodiment of the present invention, the software represented in FIG. 4 would be performed on a period basis of approximately once per day since its primary function is to assess the operating condition of its own system.

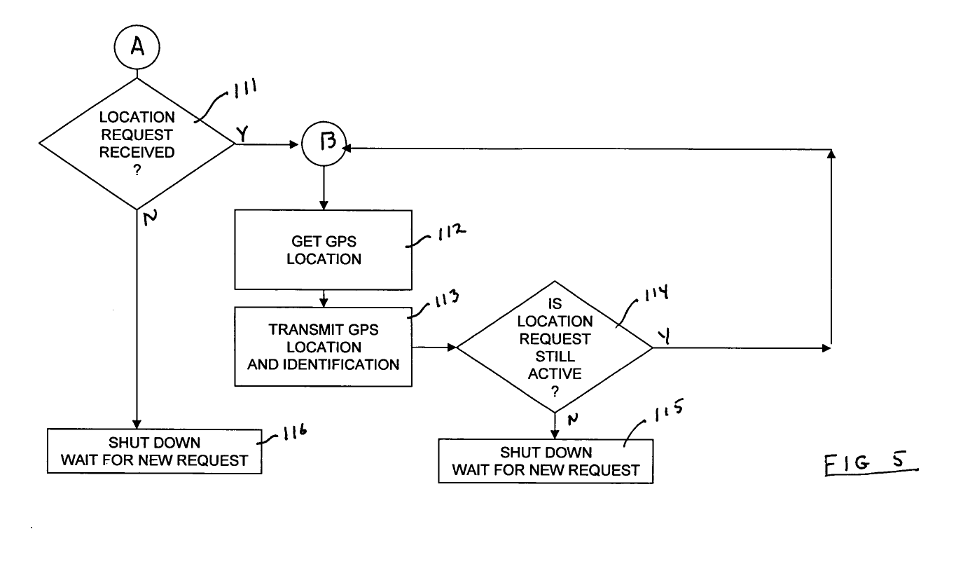

FIG. 5 represents a simplified flowchart of a software routine that would be performed when information is requested from a remote station to the outboard motor. If the location requested is received at functional block 111, the microprocessor obtains the current GPS location at functional block 112 and transmits that information to the remote station at functional block 113. It can be seen that at functional block 113, the GPS information is transmitted along with the identification 30 described above. It should be understood that the communication packet transmitted from the microprocessor to the remote station can also contain other coded passwords and identification information. This type of additional information can be used to assure that the GPS information received as a result of the transmission at functional block 113 is properly accounted for and assigned to the outboard motor 10 in question as described above. At the remote station, this information can be logged along with the time that it was received. If the location request from the remote station was made in a manner that indicates a continual need for information, the request will remain active and will be questioned at functional block 114. If it is active, the microprocessor in the engine control unit 14 will continually obtain new GPS locations at functional block 112 and transmits those locations at functional block 113 to the remote station. This will allow personnel at the remote station to track movement of the stolen outboard motor. If the location request is not active at functional block 114, the system shuts down to wait for a new individual request at functional block 115. Similarly, at functional block 116, the system will shut down if a location request is not received.

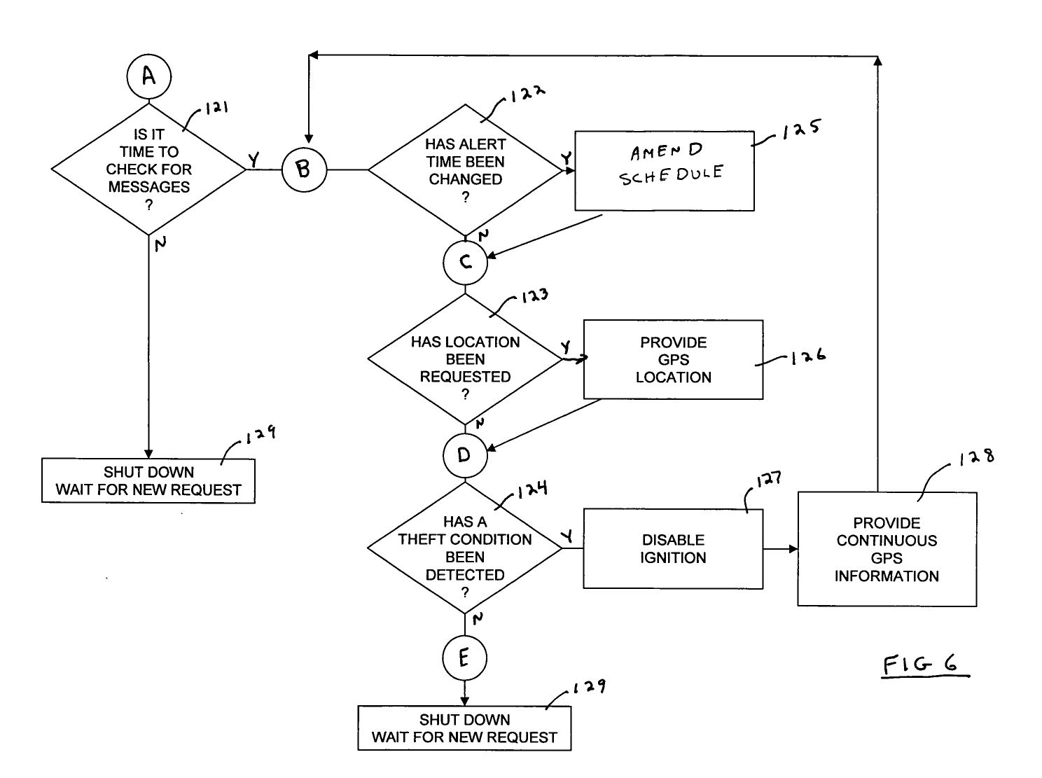

Certain embodiments of the present invention can be set up in such a way that the microprocessor in the engine control unit 14 of the outboard motor 10 will periodically check for messages from the remote station. This will occur even if no theft or missing outboard motor is reported. It is intended primarily as a method of facilitating the record keeping function of a system. As an example, a particular outboard motor may be set up in such a way that it is instructed to expect an update message from remote station at a fixed time every day (e.g. between 8:00 a.m. and 8:30 a.m.). If that message is not received, it may be an indication that something is wrong with the overall system or, possibly, that some tampering has occurred with regard to the outboard motor. If it is time to check for these types of messages, it is done at functional block 121 in FIG. 6. When the message is received, it can relate to a change in the scheduled alert time as is determined at functional block 122 or a request for GPS information at functional block 123. At functional block 124, the microprocessor checks to see if an alert has been received regarding a theft condition relating to the outboard motor. If the alert time has been changed, the microprocessor amends its schedule at functional block 125. If the location has been requested at functional block 123, the GPS information is provided at functional block 126. If a theft condition has been detected, the ignition is disabled at functional block 127 and continuous GPS to information is provided at functional block 128. Functional block 129 in FIG. 6 represents a time when the microprocessor shuts down this particular routine to wait for a new request.

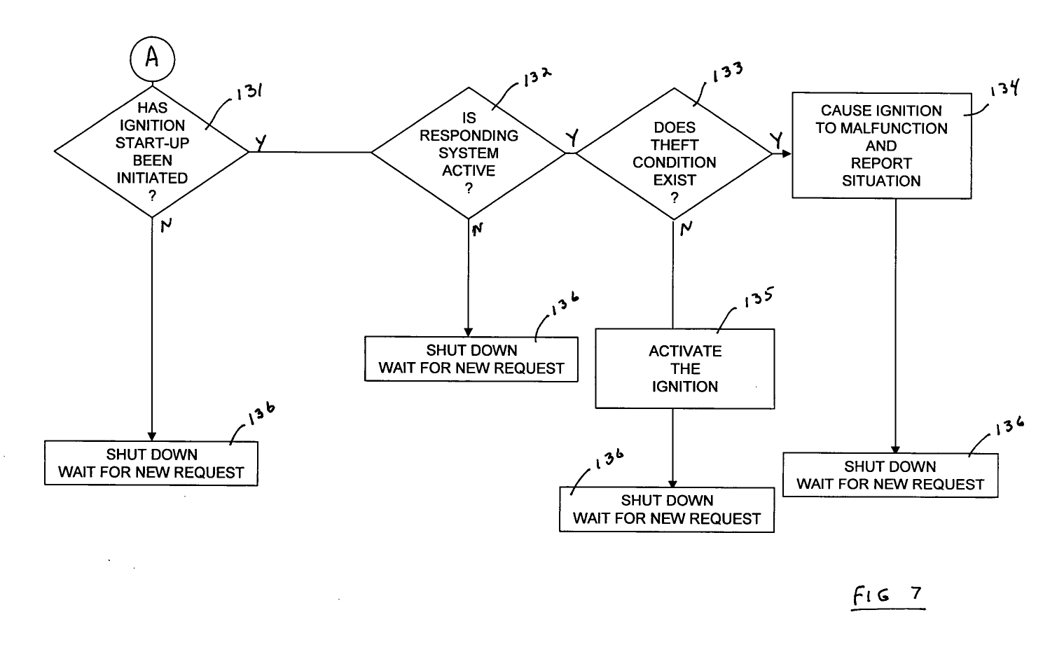

FIG. 7 is a simplified flowchart showing the steps that can be taken in certain embodiments of the present invention when the ignition system is initiated for the engine of the outboard motor 10. The ignition system startup is detected at functional block 131. At functional block 132, the system checks to see if the responding mode has been selected for this particular outboard motor. If it has been selected, the system checks at functional block 133 to see whether or not a theft condition exists. This would typically require some type of message or signal from the remote station informing the microprocessor that a theft has been reported by the owner of the outboard motor. If it has been reported, the malfunction of the engine is caused at functional block 134. If, on the other hand, no theft has been reported, the ignition is activated normally at functional block 135. The blocks identified by reference numeral 136 all result in a shutdown of the software and a wait for a new request.

With continued reference to FIGS. 1-7, it can be seen that a method for responding to a missing marine propulsion device in accordance with a preferred embodiment of the present invention comprises the steps of providing a communication system that comprises a transmitter 38 and a receiver 24 providing a microprocessor (within an engine control unit 14) which is configured to control the operation of an engine of the marine propulsion device 10, or outboard motor. The microprocessor is connected in signal communication with the receiver 24. The preferred embodiment of the present invention further comprises the steps of receiving a message from a remote source relating to a marine propulsion device 10, determining if the message relates to a missing status of the marine propulsion device, causing the marine propulsion device to malfunction in a preselected manner in response to a message relating to the missing status of the marine propulsion device, providing a global position satellite system receiver 50, receiving a current position of the marine propulsion device in transmitting the current position to the remote source. In certain embodiments of the present invention, this method can further comprise the step of repeating the current position transmitting step periodically in response to receipt of the message relating to the missing status of the marine propulsion device. In certain other embodiments, the method can further comprise the steps of transmitting an operability status inquiry to the remote source and determining if the communication system is operating properly in response to the operability status inquiry transmitting step. This embodiment of the present invention can further comprise the step of causing the marine propulsion device to malfunction in a preselected manner in response to a determined inoperability status of the marine propulsion device.

As described above, many different types of tracking systems are well known to those skilled in the art. These systems typically use a GPS system to determine the location of missing property or, in certain cases, a missing person and then proceed to track that missing property or person using the information provided by the GPS system. One inherent problem in these types of systems is that the transmission system can be disabled by a skilled thief. In certain instances, the system can be disabled by simply damaging or removing the antenna from the transmitter and/or receiver. One of the primary purposes of the present invention is to defeat that type of attempt to damage or disable the communication system or the GPS system. If this type of disabling act is detected, the preferred embodiments of the present invention are configured to react to that detection and cause a malfunction of the engine. The thief will be deprived of the use of the stolen outboard motor and, in certain cases, it is expected that the thief or a co-conspirator will attempt to have the outboard motor repaired. At this point, an alert will have already been received by authorized repair stations and the outboard motor can be recovered when it is identified by its identification and/or serial number. This added ability of the system to disable itself provides additional assistance in returning the lost or stolen property to the rightful owner. It also is increases the likelihood that the thief will be captured. If potential thieves learn of this type of system, and are aware that disabling the communication system will not be effective, it is likely that the theft of outboard motors with its system incorporated in their microprocessors will significantly decrease.

Although the present invention has been described with particular detail and specificity to illustrate several preferred embodiments, it should be understood that alternative embodiments are also within its scope.

1. A method for responding to a missing marine propulsion device, comprising the steps of:
providing a communication system comprising a receiver;
providing an engine control system including a microprocessor which is configured to control the operation of an engine of said marine propulsion device, said microprocessor being connected in signal communication with said receiver;
receiving a message from a remote source relating to said marine propulsion device;
determining if said message relates to a missing status of said marine propulsion device;
causing said marine propulsion device, in response to said message relating to said missing status of said marine propulsion device, to malfunction in a preselected manner; and
wherein said engine control system disables itself in response to said message.

2. The method of claim 1, wherein:
said causing step causes said microprocessor to prevent said engine from starting.

3. The method of claim 1, wherein:
said causing step causes said microprocessor to prevent said engine from operating above idle speed.

4. The method of claim 1, wherein:
said causing step causes said microprocessor to prevent said engine from operating for longer than a preselected time period.

5. The method of claim 1, wherein:
said communication system further comprises a transmitter.

6. The method of claim 1, further comprising:
transmitting a response to said remote source acknowledging receipt of said message.

7. The method of claim 6, further comprising:
providing a global position satellite system receiver;
receiving a current position of said marine propulsion device; and
transmitting said current position to said remote source.

8. The method of claim 7, further comprising:
repeating said current position transmitting step periodically in response to receipt of said message relating to said missing status of said marine propulsion device.

9. The method of claim 5, further comprising:
transmitting an operability status inquiry to said remote source.

10. The method of claim 9, further comprising:
determining, in response to said operability status inquiry transmitting step, if said communication system is operating properly; and
causing said marine propulsion device, in response to a determined inoperability status of said marine propulsion device, to malfunction in a preselected manner.

11. A method for responding to a missing marine propulsion device, comprising the steps of:
providing a communication system comprising a transmitter and a receiver;
providing an engine control system including a microprocessor which is configured to control the operation of an engine of said marine propulsion device, said microprocessor being connected in signal communication with said communication system;
receiving a message from a remote source relating to said marine propulsion device;
determining if said message relates to a missing status of said marine propulsion device;
causing said marine propulsion device, in response to said message relating to said missing status of said marine propulsion device, to malfunction in a preselected manner; and
wherein said engine control system disables itself in response to said message.

12. The method of claim 11, further comprising:
providing a global position satellite system receiver;
receiving a current position of said marine propulsion device; and
transmitting said current position to said remote source.

13. The method of claim 12, further comprising:
repeating said current position transmitting step periodically in response to receipt of said message relating to said missing status of said marine propulsion device.

14. The method of claim 11 further comprising:
transmitting a response to said remote source acknowledging receipt of said message.

15. The method of claim 11, wherein:
said causing step comprises a step selected from the group consisting of causing said microprocessor to prevent said engine from starting, causing said microprocessor to prevent said engine from operating above idle speed and causing said microprocessor to prevent said engine from operating for longer than a preselected time period.

16. The method of claim 11, further comprising:
transmitting an operability status inquiry to said remote source.

17. The method of claim 16, further comprising:
determining, in response to said operability status inquiry transmitting step, if said communication system is operating properly; and
causing said marine propulsion device, in response to a determined inoperability status of said marine propulsion device, to malfunction in a preselected manner.

18. A method for responding to a missing marine propulsion device, comprising the steps of:
providing a communication system comprising a transmitter and a receiver;
providing an engine control system including a microprocessor which is configured to control the operation of an engine of said marine propulsion device, said microprocessor being connected in signal communication with said receiver;
receiving a message from a remote source relating to said marine propulsion device;
determining if said message relates to a missing status of said marine propulsion device;
causing said marine propulsion device, in response to said message relating to said missing status of said marine propulsion device, to malfunction in a preselected manner;
providing a global position satellite system receiver;
receiving a current position of said marine propulsion device;
transmitting said current position to said remote source; and
wherein said engine control system disables itself in response to said message.

19. The method of claim 18, further comprising:
repeating said current position transmitting step periodically in response to receipt of said message relating to said missing status of said marine propulsion device.

20. The method of claim 18, further comprising:
transmitting an operability status inquiry to said remote source;
determining, in response to said operability status inquiry transmitting step, if said communication system is operating properly; and
causing said marine propulsion device, in response to a determined inoperability status of said marine propulsion device, to malfunction in a preselected manner.
